(19) United States
(12) Patent Application Publication
(10) Pub. No.: US 2004/0123500 A1
(43) Pub. Date: Jul. 1, 2004

(54) Three-dimensional puzzle hanging ornament

(76) Inventor: Tung Yan Lau, Hong Kong (HK)

Correspondence Address: Mr. Eric Chan, 42 Pin Oaks Drive, Phoenixville, PA, 19460, US

(21) Appl. No.: 10/737,075

(22) Filed: Dec. 12, 2003

(30) Foreign Application Priority Data
Dec. 18, 2002 (CN) 02291421.8

(51) Int. Cl. G09F 1/00

(52) U.S. Cl. 40/124.01

(57) ABSTRACT

The present invention relates to a three-dimensional puzzle hanging ornament comprising a ring, a bolt, a hanging ornament body and a layer of puzzle pieces. The hanging ornament body is three-dimensional in shape and has a round opening with screw threads inside. The front end of the bolt has screw threads. The surface of the front end of the bolt is made of magnet. The surface of the hanging ornament body, onto which the puzzle pieces are attached, is magnetic. The present invention is portable, with pieces not easily fallen off and is convenient to play with. As the present invention is three-dimensional in shape, it has higher entertainment and aesthetic value than conventional two-dimensional puzzles. The present invention can serve as a dual-purpose entertainment and ornamental object, the appearance of which is attractive and decorative. This is in contrast to conventional puzzles, which only serve a single gaming purpose.

### BACKGROUND OF THE INVENTION

The present invention relates to hanging ornaments and more particularly pertains to a three-dimensional puzzle hanging ornament which can be used as a pendent for key-holders, phone straps, necklaces, bracelets and anklets for hanging on handbags, schoolbags, pencil bags and belts as a hanging ornament.

The available puzzles in the marketplace are usually two-dimensional. As puzzles are bulk in size, and individual puzzle pieces are easily lost, puzzles are usually played in stationary indoor areas. The disadvantages include the inconvenience to carry the puzzles around, the occupation of space and the limitation on time and venue for playing the game. On the other hand, the designs of the available hanging ornaments are usually based on aesthetics without incorporating any gaming properties.

### BRIEF SUMMARY OF THE INVENTION

In view of the aforesaid disadvantages now present in the prior art, the present invention provides a three-dimensional puzzle hanging ornament which is portable, of special design and can be played at any time. The present invention can be used for a game of puzzle as well as an ornament.

To attain this, the present invention generally comprises a hanging ornament body, a layer of puzzle pieces which can be attached onto the surface of the hanging ornament body, a bolt which engages with the hanging ornament body, and a ring which passes through the bolt. The hanging ornament body is three-dimensional in the shape of a sphere, a cube, an olive or any three-dimensional cartoon character.

The layer comprises a plurality of interlocking puzzle pieces.

The surface of the hanging ornament body, onto which the puzzle pieces are attached, is magnetic.

The surface of the front end of the bolt is made of magnet.

The hanging ornament body has a round opening with screw threads inside. The front end of the bolt has screw threads. The bolt and the hanging ornament body can be screwed together.

Alternatively, the hanging ornament body has an opening with notches. The front end of the bolt has projections corresponding to the notches. The bolt and the hanging ornament body can be slotted together.

It is an object of the present invention to provide a three-dimensional puzzle hanging ornament which is portable, with pieces not easily fallen off and is convenient to play with. As the present invention is three-dimensional in shape, it has higher entertainment and aesthetic value than conventional two-dimensional puzzles. The present invention can serve as a dual-purpose entertainment and ornamental object, the appearance of which is attractive and decorative. This is in contrast to conventional puzzles, which can only serve a single gaming purpose.

### BRIEF DESCRIPTION OF THE DRAWINGS

FIG. 1 is a perspective view showing the configuration of an embodiment of the present invention.

FIG. 2 shows the configuration of the ring of the embodiment of the present invention.

FIG. 3 is a top plan view of the hanging ornament body of the embodiment of the present invention.

### DETAILED DESCRIPTION OF THE INVENTION

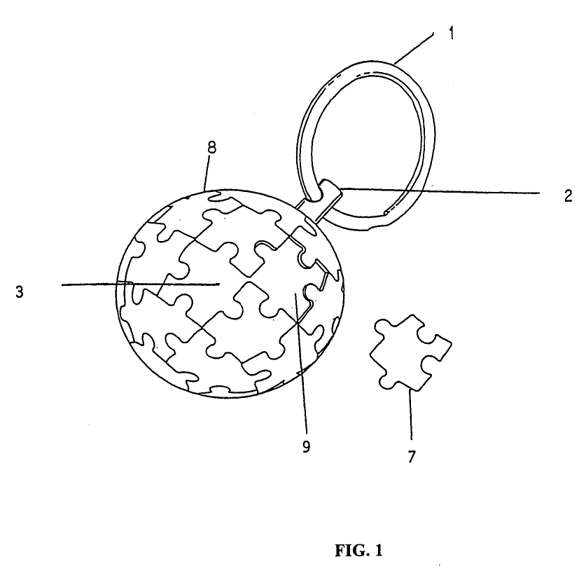

As illustrated in FIG. 1, the hanging ornament body of the present embodiment is in the shape of a sphere. It comprises a ring 1, a bolt 2, a hanging ornament body 3 and a puzzle layer 8. The bolt 2 is engaged with the hanging ornament body 3. The ring 1 passes through the bolt 2. The puzzle layer 8 comprises a plurality of interlocking puzzle pieces 7, which can be attached onto the surface of the hanging ornament body 3.

When the present invention is used as a hanging ornament, the hanging ornament body 3 can be in other three-dimensional shapes such as cubes, rectangular blocks, ellipsoids and the like. It can also be in the shape of any three-dimensional cartoon character to enhance the entertainment value. The puzzle pieces 7 can be in the form of ordinary jigsaw puzzle pieces, each of which has two projections and two recesses, so that the puzzle pieces 7 can interlock with one another. The puzzle pieces 7 can also be designed as other irregular concave and convex pieces according to the shape of the hanging ornament body 3. For instance, if the hanging ornament body 3 is in the shape of a cartoon animal character, the puzzle pieces 7 can be the eyes or ears of the animal, the shape of which can be freely changed and matched. The puzzle layer 8 can be in any pattern or design according to different styles or preferences, the scope of which is not limited by the present invention.

The puzzle layer 8 can be attached onto the hanging ornament body 3 by various methods, one of which is to configure the surface of the hanging ornament body 3 onto which the puzzle pieces 7 are attached as a magnetic body 9, so that each puzzle piece 7 can be individually attracted and attached onto the surface of the hanging ornament body 3.

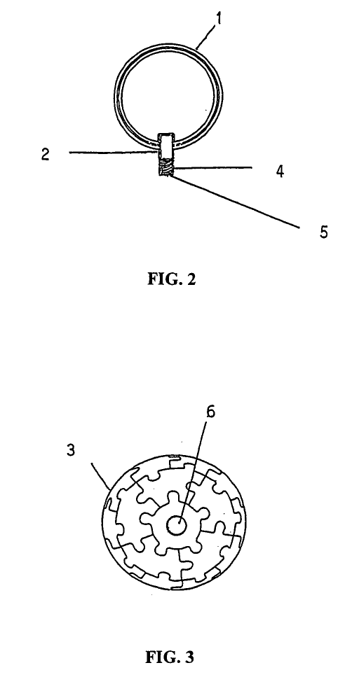

As illustrated in FIG. 2, the ring portion comprises the ring 1 and the bolt 2. The ring 1 passes through the bolt 2. The other end of the bolt 2 is engaged with the hanging ornament body 3. One method of engagement is as follows: The front end of the bolt 2 has screw threads 4. The top centre part of the hanging ornament body 3 has a round opening 6 with screw threads inside. As shown in FIG. 3, the opening 6 and the screw threads 4 at the front end of the bolt 2 can be screwed together to connect the ring 1 with the hanging ornament body 3. Another method of engagement is as follows: The hanging ornament body 3 has an opening 6 with notches. The front end of the bolt 2 has projections corresponding to the notches. The bolt 2 and the hanging ornament body 3 can be slotted together via the engagement of the notches and the projections (not shown in the drawings). There can be various methods of engagement, which are not detailed herein. The position of the opening 6 can be at any place which is convenient for placing the puzzle pieces 7 and conforms to the aesthetic standards required.

As shown in FIG. 2, the front end of the bolt 2 is made of magnet 5 and the function of which is to be used to remove the puzzle pieces 7 one by one from the hanging ornament body 3, and to place the puzzle pieces 7 one by one back onto the hanging ornament body 3.

Alternatively, the puzzle pieces 7 can be removed one by one by fingers, and placed back to the hanging ornament body 3 one by one by fingers.

The three-dimensional puzzle hanging ornament as disclosed in the above description is unique in design. It can be used as a puzzle gaming device as well as a piece of ornament.

What is claimed is:

1. A three-dimensional puzzle hanging ornament comprising:
a hanging ornament body in three-dimensional shape;
a layer of puzzle pieces which can be attached onto the surface of the hanging ornament body;
a bolt which engages with the hanging ornament body; and
a ring which passes through the bolt.

2. A three-dimensional puzzle hanging ornament as in claim 1, wherein the layer of puzzle pieces comprises a plurality of interlocking puzzle pieces.

3. A three-dimensional puzzle hanging ornament as in claim 2, wherein the surface of the hanging ornament body, onto which the puzzle pieces are attached, is magnetic.

4. A three-dimensional puzzle hanging ornament as in claim 1, wherein the hanging ornament body is in the shape of a sphere.

5. A three-dimensional puzzle hanging ornament as in claim 1, wherein the hanging ornament body is in the shape of a cube.

6. A three-dimensional puzzle hanging ornament as in claim 1, wherein the hanging ornament body is in the shape of an olive.

7. A three-dimensional puzzle hanging ornament as in claim 1, wherein the hanging ornament body is in the shape of a three-dimensional cartoon character.

8. A three-dimensional puzzle hanging ornament as in any of claim 1 to 7, wherein the surface of the front end of the bolt is made of magnet.

9. A three-dimensional puzzle hanging ornament as in any of claim 1 to 7, wherein the hanging ornament body has a round opening with screw threads inside; the front end of the bolt has screw threads; the bolt and the hanging ornament body can be screwed together.

10. A three-dimensional puzzle hanging ornament as in any of claim 1 to 7, wherein the hanging ornament body has an opening with notches; the front end of the bolt has projections corresponding to the notches; the bolt and the hanging ornament body can be slotted together.
